(19) United States
(12) Patent Application Publication
(10) Pub. No.: US 2017/0054612 A1
(43) Pub. Date: Feb. 23, 2017

(54) TROUBLE DETECTING APPARATUS AND SYSTEM

(71) Applicant: FUJITSU LIMITED, Kawasaki-shi (JP)

(72) Inventors: Su YI, Beijing (CN); Hao WANG, Beijing (CN); Jun TIAN, Beijing (CN); Xiaojing FAN, Beijing (CN); Lefei WANG, Beijing (CN); Wenqian XUE, Beijing (CN); Ryuichi MATSUKURA, Kawasaki-shi (JP)

(73) Assignee: FUJITSU LIMITED, Kawasaki-shi (JP)

(21) Appl. No.: 15/236,027

(22) Filed: Aug. 12, 2016

(30) Foreign Application Priority Data
Aug. 18, 2015 (CN) 201510508995.7

(51) Int. Cl. H04L 12/26; H04B 17/318; H04W 4/00

(52) U.S. Cl. CPC H04L 43/04; H04W 4/005; H04L 43/12; H04L 43/067; H04L 43/0829; H04L 43/0847; H04B 17/318

(57) ABSTRACT

Embodiments of the present invention provide a trouble detecting apparatus and system. Wherein, the trouble detecting apparatus includes: a first acquiring unit configured to periodically acquire information relating to communication and/or a channel; a first counting unit configured to statistically calculate the acquired information, so as to obtain first statistic data; and a first detecting unit configured to perform trouble detection by using the first statistic data and prestored training data, so as to obtain a trouble detection result. With the apparatus and system of the embodiments, not only multiple possible communication troubles may be detected, but also the signaling overhead is relatively low, thereby achieving low complexity.

### TECHNICAL FIELD

The present invention relates to the field of communications, and in particular to a trouble detecting apparatus and system.

### BACKGROUND ART

The Internet of Things (IoT) collects various information on any objects needing to be monitored, connected and interacted in a real-time manner, so as to achieve connection between things, between things and human being, and between all articles and a network, and facilitate identification, administration and control. Entities in an IoT usually include sensors and devices, gateways, networks, cloud, and applications.

However, an existing sensor provides inadequate coverage and unpredictable network performance. The reasons leading to the degraded performance include dense deployment, noise and interference. And unlike the wired counterpart, a wireless link is easily affected by environment changes. State monitoring and trouble diagnosis in both link level and network level are essential components to operate an IoT.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY OF THE INVENTION

Among all the troubles, the most common and frequent ones are those related with wireless transmission. These troubles are generally caused by fading, low received signal strength, and interference. In order to detect multiple possible communication troubles, embodiments of the present invention provide a trouble detecting apparatus and system, in which not only multiple possible troubles may be detected, but also the signaling overhead is relatively low, thereby achieving relatively low complexity.

According to a first aspect of the embodiments of the present invention, there is provided a trouble detecting apparatus, characterized in that the apparatus includes:

a first acquiring unit configured to periodically acquire information relating to communication and/or a channel;

a first counting unit configured to statistically calculate the acquired information, so as to obtain first statistic data; and

a first detecting unit configured to perform trouble detection by using the first statistic data and prestored training data, so as to obtain a trouble detection result.

According to a second aspect of the embodiments of the present invention, there is provided a trouble detecting system, including a gateway and an access point, characterized in that:

the access point periodically acquires information relating to communication and/or a channel, and reports the information to the gateway;

and the gateway statistically calculates the acquired information, so as to obtain first statistic data, and performs trouble detection by using the first statistic data and prestored training data, so as to obtain a trouble detection result.

According to a third aspect of the embodiments of the present invention, there is provided a trouble detecting system, including a gateway and an access point, characterized in that:

the access point periodically acquires information relating to communication and/or a channel, statistically calculates the acquired information, so as to obtain first statistic data, performs trouble detection by using the first statistic data and prestored training data, so as to obtain a trouble detection result, and reports the trouble detection result to the gateway.

According to a fourth aspect of the embodiments of the present invention, there is provided a trouble detecting system, including a gateway and an access point, characterized in that:

the access point periodically acquires information relating to communication and/or a channel, statistically calculates the acquired information, so as to obtain first statistic data, and reports the first statistic data to the gateway;

and the gateway performs trouble detection by using the first statistic data and prestored training data, so as to obtain a trouble detection result.

An advantage of the embodiments of the present invention exists in that by periodically acquiring the information relating to communication and/or a channel, statistically processing the information, and performing trouble detection on the statistically processed information, not only multiple possible communication troubles may be detected, but also the signaling overhead is relatively low, thereby achieving low complexity.

With reference to the following description and drawings, the particular embodiments of the present invention are disclosed in detail, and the principle of the present invention and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may obtain other accompanying drawings according to these accompanying drawings without making an inventive effort. In the drawings:

FIG. 1 is a flowchart of the trouble detecting method of Embodiment 1;

FIG. 2 is a flowchart of an implementation of step 102 of Embodiment 1;

FIG. 3 is schematic diagrams of information on a transmitting end and first statistic data of Embodiment 1;

FIG. 4 is a flowchart of another implementation of step 102 of Embodiment 1;

FIG. 5 is schematic diagrams of a structure of information on a receiving end and first statistic data of Embodiment 1;

FIG. 6 is a schematic diagram of a structure of the trouble detecting apparatus of Embodiment 2;

FIG. 7 is a schematic diagram of an implementation of a first counting unit 602 in Embodiment 2;

FIG. 8 is a schematic diagram of another implementation of the first counting unit 602 in Embodiment 2;

FIG. 9 is a schematic diagram of a structure of an access point in Embodiment 3;

FIG. 10 is a schematic diagram of a structure of a gateway in Embodiment 5;

FIG. 11 is a schematic diagram of a structure of the trouble detecting system in Embodiment 8;

FIG. 12 is a schematic diagram of a structure of the trouble detecting system in Embodiment 9; and

FIG. 13 is a schematic diagram of a structure of the trouble detecting system in Embodiment 10.

### DETAILED DESCRIPTION OF THE INVENTION

These and further aspects and features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

The embodiments of the present invention shall be described taking an IoT as an example. However, it should be understood that the embodiments of the present invention are not limited to an IoT. For example, the method and apparatus provided by the embodiments of the present invention are also applicable to other wireless networks, such as wireless local area network (WLAN), etc.

### Embodiment 1

Embodiment 1 provides a trouble detecting method. FIG. 1 is a flowchart of the trouble detecting method of Embodiment 1. Referring to FIG. 1, the method includes:

step 101: periodically acquiring information relating to communication and/or a channel;

step 102: statistically calculate the acquired information, so as to obtain first statistic data; and

step 103: performing trouble detection by using the first statistic data and prestored training data, so as to obtain a trouble detection result.

In this embodiment, by periodically acquiring the information relating to communication and/or a channel, statistically processing the information, and performing trouble detection on the statistically processed information, not only multiple possible communication troubles may be detected, but also the signaling overhead is relatively low, thereby achieving low complexity.

In this embodiment, in step 101, the information relating to communication may be a network information log derived from packets defined by Institute of Electrical and Electronics Engineers (IEEE) standard or others, and the information relating to a channel may be a channel information log on a physical layer defined by IEEE standard or others. Definitions in existing standards may be referred to for particular formats of the network information log and channel information log, which shall not be enumerated herein any further. Hence, in step 102, in statically calculating the information acquired in step 101, communication features and/or channel features in the above network information log and/or channel information log may be statically calculated according to a type of a trouble to be detected, so as to obtain the first statistic data. For example, the communication features may include a packet drop ratio (PDR), etc.; and the channel features may include a received signal strength indicator (RSSI) in a certain period of time, and a signal to noise and interference ratio (SINR), etc.

In this embodiment, the information relating to communication and channel may be information on a receiving end and/or information on a transmitting end. For example, when a trouble detecting apparatus is taken as a transmitter in a packet communication process, the information relating to communication and channel is the information on a transmitting end, and when the trouble detecting apparatus is taken as a receiver in the packet communication process, the information relating to communication and channel is the information on a receiving end. For example, when the information relating to communication and channel is the information on a transmitting end, the above network information log and/or the channel information log may be a transmission log(s), and when the information relating to communication and channel is the information on a receiving end, the above network information log and/or the channel information log may be a receiving log(s).

In this embodiment, the method may further include (not shown): reporting the trouble detection result.

In this embodiment, in order to calculate the first statistic data more accurately, in acquiring the above information relating to communication and/or a channel, a period T may be predetermined. In step 101, the information relating to communication and/or a channel is periodically acquired within T, and a method for periodically acquiring information shall be illustrated below.

Example 1: when the information is the information on a receiving end, IoT services usually need sensor devices (such as various information acquisition sensors, e.g. a temperature sensor, and a water level sensor, etc.) to periodically report data. Hence, a receiving log of the periodically reported data is periodically acquired information relating to communication and/or a channel; wherein, the receiving log may usually include a sequence number (sequence), data packet correlation information (correlation), and a data packet RSSI value, etc. Such a scenario is applicable to a sensor network application where multiple pieces of information is acquired and periodically reported, that is, existing periodic data transmission may be used to acquire the receiving log. The periodically reported data may be preconfigured, or a corresponding instruction may be transmitted to a sensor device when diagnosis is needed, indicating the sensor device to start a data reporting function.

Example 2: when the information is the information on a transmitting end, the information on a transmitting end may be acquired by periodically transmitting probe packets. For example, an apparatus performing trouble detection periodically transmits probe packets, collects a transmission log of the probe packets, and takes the transmission log as the periodically acquired information relating to communication and/or a channel; wherein, the transmission log may usually include a sequence number (sequence), data packet transmission status information (status, such as a transmission success status or a transmission failure status), data packet retransmission information (retris, such as the number of data packet retransmission), a correlation value (correlation) of acknowledgement (ACK), and an RSSI value of ACK, etc. However, this embodiment is not limited thereto. For example, the transmission log may further include link quality of ACK, signal quality of ACK, a response time, and delay, etc.

In this embodiment, in step 102, the statistic calculation is performed on the information acquired in step 101, so as to obtain the first statistic data; wherein, when the information acquired in step 101 is the information on a transmitting end, the first statistic data includes one or more pieces of the following information: packet dropping statistic information, retransmission(retry) statistic information, correlation value statistic information, and RSSI statistic information; and when the information acquired in step 101 is the information on the receiving end, the first statistic data include one or more pieces of the following information: packet dropping statistic information, duplicate statistic information, correlation value statistic information, and RSSI statistic information.

In an implementation, the packet dropping statistic information may be a packet drop ratio, the retransmission statistic information may be a retransmission ratio (a retry ratio), the duplicate statistic information may be a duplicate ratio, the correlation value statistic information may include an average value of correlation values and a standard deviation of correlation values, and the RSSI statistic information may include an average value of RSSIs, a standard deviation of RSSIs and a gradient of RSSIs, and this embodiment is not limited thereto. For example, the packet dropping statistic information may also be a total number of packet drops, the retransmission statistic information may be a total number of retransmission, the duplicate statistic information may be a total number of duplicates, etc., and the correlation value statistic information may also be correlation value variance, etc., which shall not be enumerated herein any further.

In this embodiment, the trouble detection result may include one or more of the following results: a normal status, short-time fading, a low signal strength, and interference. And the information contained in the first statistic data needing to be counted in step 102 may be determined according to a type of a trouble needing to be detected. The above trouble detection results shall be respectively described below.

A. Normal Status

In this embodiment, the normal status indicates that an environmental change does not occur in a predetermined period of time, and a channel condition is very stable. In such a status, there exists no packet drop and retry, and amplitudes of changes of RSSIs and correlation values of different packets are small (criteria for judging the amplitudes of changes are determined according to an actual situation, which are featured with that standard deviation of the RSSIs and the correlation values is relatively small). The packet dropping statistic information, retransmission statistic information, correlation value statistic information and RSSI statistic information are taken as the first statistic data. For example, the normal status is judged according to a packet drop ratio, a retry ratio, standard deviation of correlation values, and an average value and standard deviation of RSSIs.

B. Short-Time Fading

In this embodiment, the short-time fading indicates that an environmental change occurs, such as an environmental change due to motions of an object in a transmission area, or people walking around, or trembling or moving of a transceiver. When the short-time fading occurs, RSSI values fluctuate rapidly (featured with that standard deviation of the RSSIs is relatively large, and an absolute value of the gradients of the RSSIs is relatively large), and packet retry sometimes occurs. The RSSI statistic information and retransmission statistic information are taken as the first statistic data. For example, whether short-time fading occurs is judged according to a standard deviation of RSSIs, an average absolute value of the gradients of the RSSIs and a retry ratio.

C. Low Signal Strength

In this embodiment, the low signal strength is caused by blockage between a transmitter and a receiver, or decreasing of transmission power. For example, a relatively large barrier occurring between a transmitter and a receiver will cause low signal strength. Under a condition of low signal strength, RSSI value will decrease (featured with that an average value of RSSIs changes), and packet retry and packet drop sometimes occur. The RSSI statistic information, retransmission statistic information and packet dropping statistic information are taken as the first statistic data. For example, whether low signal strength occurs is judged according to an average value of RSSIs, a retry ratio and a packet drop ratio.

D. Interference

In this embodiment, as wide use of industrial, scientific and medical (ISM) bandwidth, which results in bandwidth crowded, a neighboring 802.15.4 network, WiFi network, Bluetooth and microwave oven will produce interference. Under an interference condition, a signal to interference plus noise ratio (SINR) will decrease (featured with decreasing of a correlation value), and packet retry and packet drop sometimes occur. The correlation value statistic information, retransmission statistic information and packet dropping statistic information are taken as the first statistic data. For example, whether interference occurs is judged according to an average value of correlation values, a retry ratio and a packet drop ratio.

Hence, in this embodiment, in order to detect troubles of different types, statistic data featuring the troubles may be selected. For example, in need of detecting trouble types of short-time fading and low signal strength, the first statistic data need to include the RSSI statistic information, retransmission statistic information and packet dropping statistic information, so as to be able to judge a corresponding trouble according to the statistic information. For example, in need of detecting a trouble type of interference, the first statistic data need to include the correlation value statistic information, retransmission statistic information and packet dropping statistic information, so as to be able to judge whether interference occurs according to the statistic information. For example, in need of detecting the above four types of trouble detection results, the first statistic data need to include the packet dropping statistic information, retransmission statistic information, correlation value statistic information and RSSI statistic information, and this embodiment is not limited thereto.

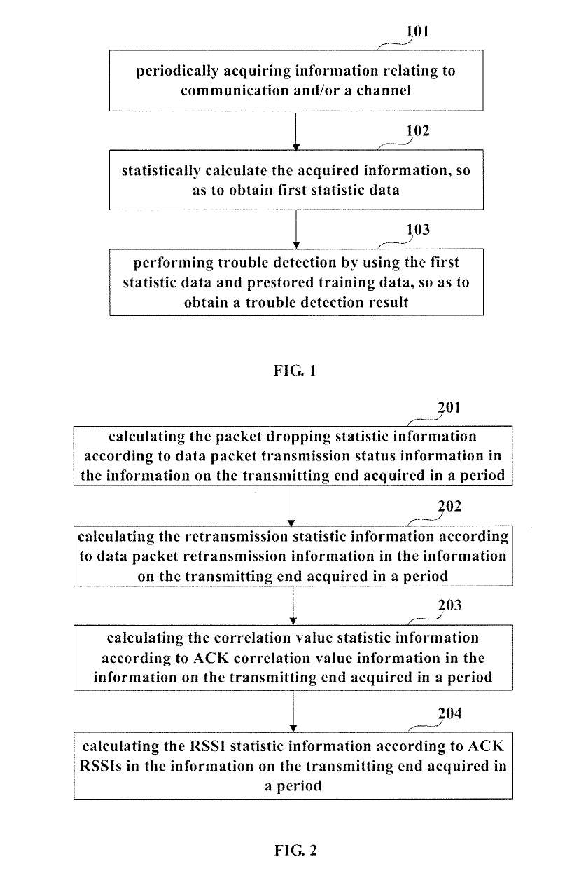

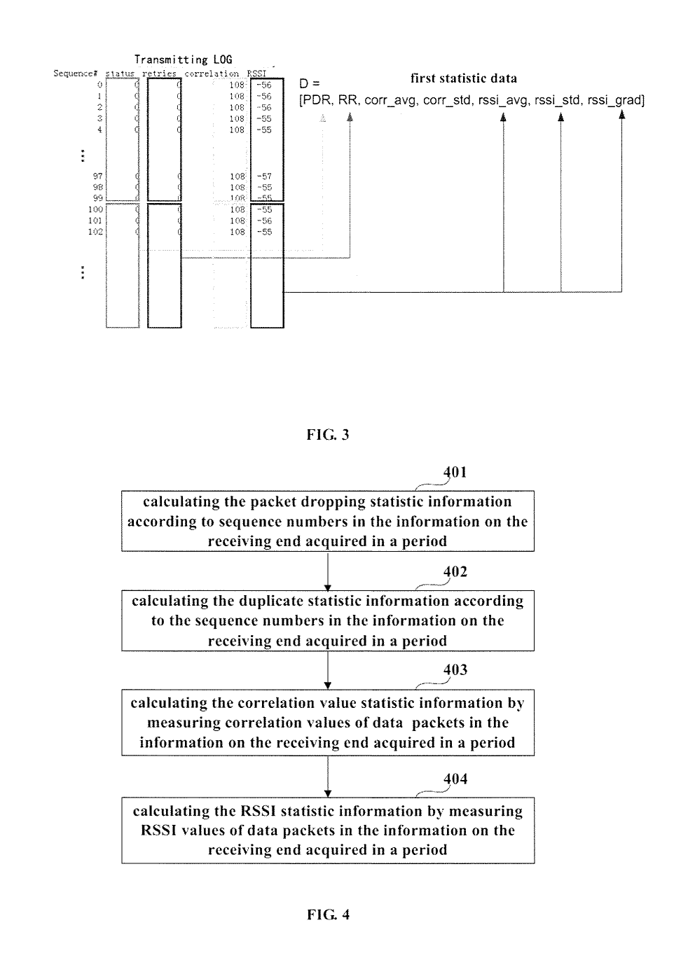

In this embodiment, as the information on the receiving end and the information on the transmitting end are different, respective statistic calculation method for obtaining the first statistic data are also different. FIG. 2 is a flowchart of a method for obtaining the first statistic data by performing statistic calculation on data of the transmitting end in step 102, and FIG. 3 is schematic diagrams of the information on the transmitting end and the first statistic data thereof of this embodiment. How to obtain the first statistic data of the transmitting end shall be described below with reference to FIGS. 2 and 3.

As shown in FIG. 2, the method for performing statistic calculation on the information on the transmitting end includes:

step 201: calculating the packet dropping statistic information according to data packet transmission status information in the information on the transmitting end acquired in a period;

step 202: calculating the retransmission statistic information according to data packet retransmission information in the information on the transmitting end acquired in a period;

step 203: calculating the correlation value statistic information according to acknowledgement (ACK) correlation value information in the information on the transmitting end acquired in a period; and

step 204: calculating the RSSI statistic information according to ACK RSSIs in the information on the transmitting end acquired in a period.

The method of statistic calculation of the information on the transmitting end shall be described below by way of examples with reference to FIG. 3. As shown in FIG. 3, the information on the transmitting end includes a sequence number (sequence shown in FIG. 3), data packet transmission status information (status shown in FIG. 3, status 0 denotes transmission success, and status 1 denotes transmission failure), packet retransmission information (retries shown in FIG. 3, 0 denotes being not retransmitted), a ACK correlation value information (correlation as shown in FIG. 3), and an RSSI value of ACK; and the first statistic data include packet dropping statistic information, retransmission statistic information, correlation value statistic information, and RSSI statistic information. Wherein, the packet dropping statistic information is a packet drop ratio (PDR), the retransmission statistic information is a retry ratio (RR), the correlation value statistic information is an average value of correlation values (corr_avg shown in FIG. 3) and standard deviation of correlation values (corr_std shown in FIG. 3), and the RSSI statistic information is an average value of RSSIs (rssi_avg shown in FIG. 3), a standard deviation of RSSIs (rssi_std shown in FIG. 3) and a gradient of RSSIs (rssi_grad shown in FIG. 3). And a particular method for calculating the first statistic data is as follows:

for example, when the information on a transmitting end acquired in a period T is N transmission logs, counting that a transmission status in packet transmission status information in the N transmission logs is the number of failures, and calculating a packet drop ratio (PDR); counting the number of retried packets in the N transmission logs, and calculating a retry ratio (RR); counting ACK correlation values of the N transmission logs, and calculating a correlation value average value (corr_avg) and a correlation value standard deviation(corr_std) of the N ACK correlation values; counting ACK RSSIs of the N transmission logs, and calculating an RSSI average value (rssi_avg), an RSSI standard deviation(rssi_std) and an RSSI gradient (rssi_grad) of the N ACK RSSIs; wherein, an average value of an absolute value of gradients of the N ACK RSSIs may be taken as the rssi_grad, so as to obtain a 7-dimensional vector and take it as the first counting data, which is expressed as follows by Formula (1): D=[PDR, RR, corr_avg, corr_std, rssi_avg, rssi_std, rssi_grad]; what described above is illustrative only, and the first counting data is not limited to the above 7-dimensional vector; for example, the first counting data a 6-dimensional vector or an 8-dimensional vector, and this embodiment is not limited thereto.

FIG. 4 is a flowchart of a method for obtaining the first statistic data by performing statistic calculation on data of the receiving end in step 102, and FIG. 5 is schematic diagrams of the information on the receiving end and the first statistic data thereof of this embodiment. How to obtain the first statistic data of the receiving end shall be described below with reference to FIGS. 4 and 5.

As shown in FIG. 4, the method for performing statistic calculation on the data of the receiving end includes:

step 401: calculating the packet dropping statistic information according to sequence numbers in the information on the receiving end acquired in a period;

step 402: calculating the duplicate statistic information according to the sequence numbers in the information on the receiving end acquired in a period;

step 403: calculating the correlation value statistic information by measuring correlation values of data packets in the information on the receiving end acquired in a period; and

step 404: calculating the RSSI statistic information by measuring RSSI values of data packets in the information on the receiving end acquired in a period.

The method of statistic calculation of the information on the receiving end shall be described below by way of examples with reference to FIG. 5. As shown in FIG. 5, the information on the receiving end includes a sequence number (sequence), packet correlation value information (correlation), and data packet RSSIs, etc.; and the first statistic data include packet dropping statistic information, duplicate statistic information, correlation value statistic information, and RSSI statistic information. Wherein, the packet dropping statistic information is a packet drop ratio (PDR), the duplicate statistic information is a duplicate ratio (DR), the correlation value statistic information is an average value of correlation values (corr_avg) and standard deviation of correlation values (corr_std), and the RSSI statistic information is an average value of RSSIs (rssi_avg), standard deviation of RSSIs (rssi_std) and a gradient of RSSIs (rssi_grad). And a particular method for calculating the first statistic data is as follows:

for example, when the information on a receiving end acquired in a period T is N receiving logs, as information on the receiving logs and that on the transmission logs are different, for example, the receiving logs do not include data packet transmission status, packet retries information and ACK information, in calculating the first counting data, the method of statistic calculation of the receiving logs is different from the method of statistic calculation of the transmission logs; wherein, in steps 401 and 402, the packet dropping statistic information and the duplicate statistic information are calculated by using a sequence number; for example, whether there exist drop packet may be judged according to whether sequence numbers are continuous, so as to obtain the packet dropping statistic information; whether there exist duplicates may be judged according to whether sequence numbers are repeated, so as to obtain the duplicate statistic information; and furthermore, the correlation value statistic information and the RSSI statistic information are calculated by measuring the correlation values and RSSI values of data packets in the receiving logs, so as to obtain the first statistic data. The prior art may be referred to for a particular measurement and calculation method, which shall not be described herein any further.

In this embodiment, steps 201-204 and steps 401-404 may be executed in any order, and orders of execution are not limited to those shown in FIGS. 2 and 4, and related statistic information may be selected according to an actual situation, and this embodiment is not limited thereto.

In this embodiment, with the statistic calculation methods in FIGS. 2 and 4, the information relating to communication and/or a channel acquired in step 101 may be standardized into a unified data model, such as standardizing the information relating to communication and/or a channel into a unified 7-dimensional vector (a data model), thereby being able to process information on various types of devices, and lowering complexity of trouble detection.

In this embodiment, in step 103, after the first statistic data are obtained, the trouble detection may be performed in conjunction with prestored training data. In this embodiment, the prestored training data may be obtained in a manner as follows: pre-obtaining the information relating to communication and/or a channel at a normal state and with different trouble types, and training the information, a particular training method being similar to the prior art, such as artificially selecting or making interested scenarios at a normal state and with different trouble types under a network environment where detection is needed, and calibrating the first statistic data of the log data acquired in such scenarios with scenarios of corresponding trouble types, so as to form the training data; after the training is finished, obtaining different training data respectively corresponding to the normal state and different trouble types. As the training data to which the trouble detection results correspond are different, the first statistic data are compared with the prestored training data, so as to determine the trouble detection results corresponding to the first statistic data.

In this embodiment, a particular trouble detection algorithm is not limited. For example, the trouble detection may be performed by using a machine learning algorithm in the prior art, for example, the trouble detection may be performed by using a K nearest neighbor (KNN) algorithm. The trouble detection method in step 103 shall be further described below taking the information on a transmitting end acquired in step 101 as an example.

In step 103, a KNN parameter and a weighted value are optimized by using the prestored training data, and distances (i.e. Euclidian distances) between the first statistic data (such as the 7-dimensional vector) and all the prestored training data are calculated, so as to find out K nearest neighbor training data (the training data are respectively calibrated as being of a normal or trouble type in advance); wherein, which normal or trouble type corresponding to the largest number of training data in K training data are determined, and the first statistic data are sorted into the normal or trouble type containing the largest number of training data. And wherein, a value of K is given by algorithm optimization, which belongs to a conventional scope of machine learning, and shall not be described herein any further.

In this embodiment, steps 101-103 may be executed by an access point in a network, and the access point reports a trouble detection result to a gateway after obtaining the trouble detection result; or steps 101-102 may be executed by an access point in a network, and the access point reports first statistic data to a gateway after obtaining the first statistic data, and the gateway performs the trouble detection in step 103; or step 101 may be executed by an access point in a network, and the access point reports information relating to communication and/or a channel to a gateway after periodically obtaining the information relating to communication and/or a channel, and the gateway performs the calculation of the first statistic data and the trouble detection in steps 102 and 103, and this embodiment is not limited thereto.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

### Embodiment 2

Embodiment 2 provides a trouble detecting apparatus. As a principle of the apparatus for solving problems is similar to that of the method in Embodiment 1, the implementation of the method in Embodiment 1 may be referred to for implementation of the apparatus, with repeated parts being not going to be described any further.

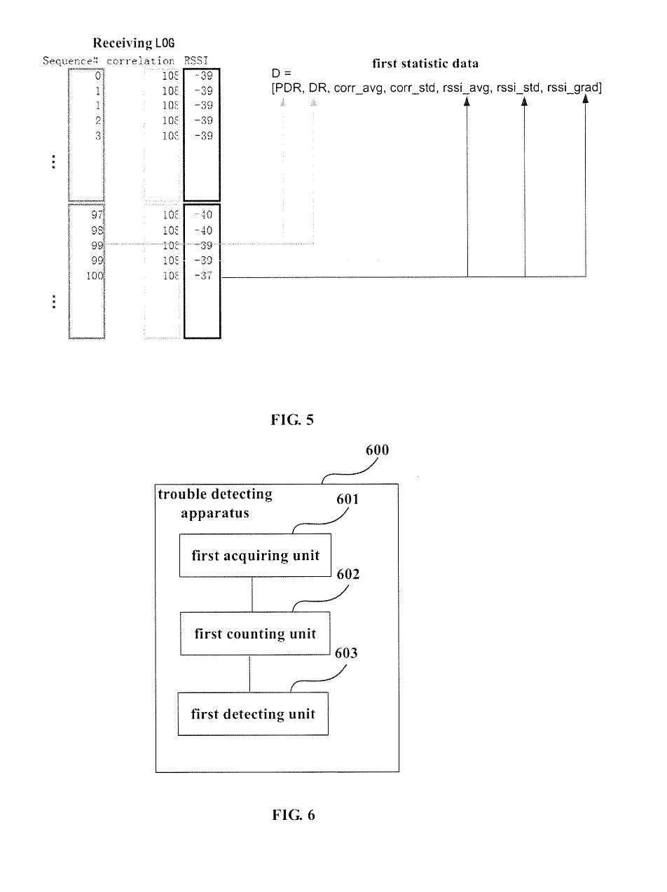

FIG. 6 is a schematic diagram of a structure of the trouble detecting apparatus of Embodiment 2, the apparatus 600 including:

a first acquiring unit 601 configured to periodically acquire information relating to communication and/or a channel;

a first counting unit 602 configured to statistically calculate the acquired information, so as to obtain first statistic data; and

a first detecting unit 603 configured to perform trouble detection by using the first statistic data and prestored training data, so as to obtain a trouble detection result.

In this embodiment, the information includes: information on a receiving end and/or information on a transmitting end; and the first acquiring unit acquires the information on the transmitting end by periodically transmitting probe packets, and step 101 in Embodiment 1 may be referred to for a particular acquisition method, which shall not be described herein any further.

In this embodiment, when the information acquired by the first acquiring unit 601 is the information on the transmitting end, the first statistic data include one or more pieces of the following information: packet dropping statistic information, retransmission statistic information, correlation value statistic information, and received signal strength indicator (RSSI) statistic information; and when the information acquired by the first acquiring unit 601 is the information on the receiving end, the first statistic data include one or more pieces of the following information: packet dropping statistic information, duplicate statistic information, correlation value statistic information, and RSSI statistic information. Embodiment 1 may be referred to for particular implementations of various statistic information and how to determine the first statistic data, which shall not be described herein any further.

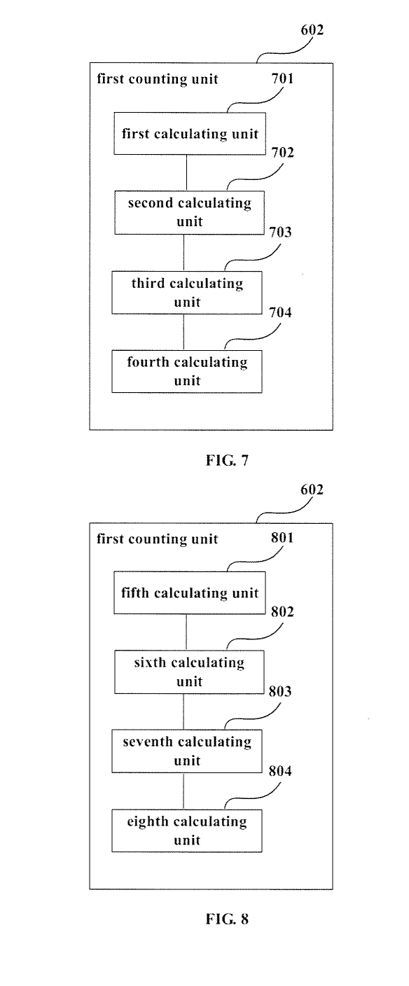

In this embodiment, FIG. 7 is a schematic diagram of an implementation of the first counting unit 602. As shown in FIG. 7, when the information acquired by the first acquiring unit 601 is the information on the receiving end, the first counting unit 602 includes:

a first calculating unit 701 configured to calculate the packet dropping statistic information according to sequence numbers in the information on the receiving end acquired in a period;

a second calculating unit 702 configured to calculate the duplicate statistic information according to sequence numbers in the information on the receiving end acquired in a period;

a third calculating unit 703 configured to calculate the correlation value statistic information by measuring correlation values of data packets in the information on the receiving end acquired in a period; and a fourth calculating unit 704 configured to calculate the RSSI statistic information by measuring RSSI values of data packets in the information on the receiving end acquired in a period.

Wherein, steps 201-204 in Embodiment 1 may be referred to for particular implementations of the first calculating unit 701, second calculating unit 702, third calculating unit 703 and fourth calculating unit 704, the contents of which being incorporated herein, which shall not be described herein any further.

In this embodiment, FIG. 8 is a schematic diagram of another implementation of the first counting unit 602. As shown in FIG. 8, when the information acquired by the first acquiring unit is the information on the transmitting end, the first counting unit 602 includes:

a fifth calculating unit 801 configured to calculate the packet dropping statistic information according to data packet transmission status information in the information on the transmitting end acquired in a period;

a sixth calculating unit 802 configured to calculate the retransmission statistic information according to data packet retransmission information in the information on the transmitting end acquired in a period;

a seventh calculating unit 803 configured to calculate the correlation value statistic information according to acknowledgement (ACK) correlation value information in the information on the transmitting end acquired in a period; and an eighth calculating unit 804 configured to calculate the RSSI statistic information according to ACK RSSIs in the information on the transmitting end acquired in a period.

Wherein, steps 401-404 in Embodiment 1 may be referred to for particular implementations of the fifth calculating unit 801, sixth calculating unit 802, seventh calculating unit 803 and eighth calculating unit 804, the contents of which being incorporated herein, which shall not be described herein any further.

In this embodiment, the calculating units in FIGS. 7 and 8 may be carried out in a combined manner, and may also be carried out in a separate manner, and this embodiment is not limited thereto.

In an implementation, the packet dropping statistic information may be a packet drop ratio, the retransmission statistic information may be a retry ratio, the duplicate statistic information may be a duplicate ratio, the correlation value statistic information may include an average value of correlation values and a standard deviation of correlation values, and the RSSI statistic information includes an average value of RSSIs, a standard deviation of RSSIs and a gradient of RSSIs, and this embodiment is not limited thereto. For example, the packet dropping statistic information may also include a total number of packet drops, the retransmission statistic information may be a total number of retries, the duplicate statistic information may be a total number of duplicates, etc., and the correlation value statistic information may also be correlation value variance, etc., which shall not be enumerated herein any further.

In this embodiment, the trouble detection result may include one or more of the following results: a normal status, short-time fading, a low signal strength, and interference. Wherein, Embodiment 1 may be referred to for detailed description of the e trouble detection results, which shall not be described herein any further.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

In Embodiment 2, the first acquiring unit 601, the first counting unit 602 and the first detecting unit 603 of the trouble detecting apparatus 600 may be simultaneously arranged in a device, so as to carry out the function of trouble detection, and may also be arranged in different devices, so as to carry out the function of trouble detection by information exchange between the devices. For example, for a communication system, the first acquiring unit 601, the first counting unit 602 and the first detecting unit 603 may be simultaneously arranged in an access point, and the access point carries out the function of trouble detection, and then reports a trouble detection result to a gateway; or the first acquiring unit 601 and the first counting unit 602 may be simultaneously arranged in an access point, and the first detecting unit 603 is arranged in a gateway, the access point periodically acquires information, calculates the first statistic data and reports them to the gateway, and the gateway carries out the trouble detection; or the first acquiring unit 601 is arranged in an access point, and the first counting unit 602 and the first detecting unit 603 are arranged in a gateway, the access point periodically acquires the information and reports the information to the gateway, and the gateway calculates the first statistic data and performs the trouble detection. The above different implementations shall be described below respectively.

It should be noted that in this embodiment, coordinators in the network are collectively referred to as access points, and central controllers, gateways and cloud in the network are collectively referred to as gateways.

### Embodiment 3

Embodiment 3 provides an access point. In this embodiment, the access point executes steps 101-103 in Embodiment 1, and reports a trouble detection result to a gateway.

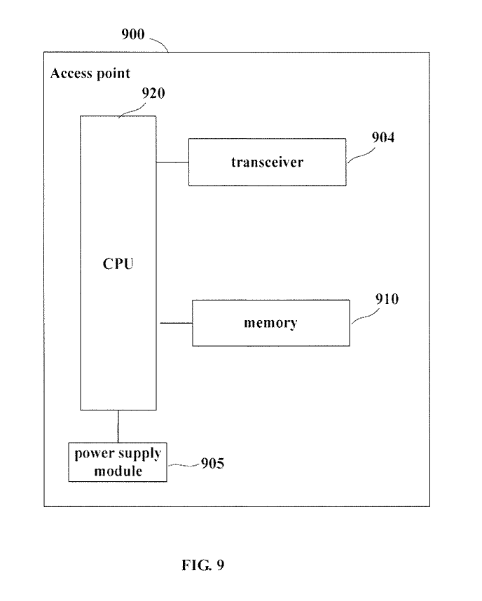

FIG. 9 is a schematic diagram of a structure of the access point of the embodiment of the present invention. As shown in FIG. 9, the access point 900 may include: an interface (not shown), a central processing unit (CPU) 920 and a memory 910, the memory 910 being coupled to the central processing unit 920. Wherein, the memory 910 may store various data, and may further store a program for trouble detection, and execute the program under control of the central processing unit 920.

In an implementation, a function of trouble detection may be integrated into the central processing unit 920. Wherein, the central processing unit 920 may be configured to: periodically acquire information relating to communication and/or a channel; statistically calculate the acquired information, so as to obtain first statistic data; and perform trouble detection by using the first statistic data and prestored training data, so as to obtain a trouble detection result.

Wherein, the information includes: information on a receiving end and/or information on a transmitting end; and the information on the transmitting end is acquired by periodically transmitting probe packets. When the acquired information is the information on the transmitting end, the first statistic data include one or more pieces of the following information: packet dropping statistic information, retransmission statistic information, correlation value statistic information, and received signal strength indicator (RSSI) statistic information. And when the acquired information is the information on the receiving end, the first statistic data include one or more pieces of the following information: packet dropping statistic information, duplicate statistic information, correlation value statistic information, and received signal strength indicators (RSSI) statistic information.

Wherein, the central processing unit 920 may further be configured to: when the acquired information is the information on the receiving end, calculate the packet dropping statistic information according to sequence numbers in the information on the receiving end acquired in a period; calculate the duplicate statistic information according to sequence numbers in the information on the receiving end acquired in a period; calculate the correlation value statistic information by measuring correlation values of data packets in the information on the receiving end acquired in a period; and calculate the RSSI statistic information by measuring RSSI values of data packets in the information on the receiving end acquired in a period.

Wherein, the central processing unit 920 may further be configured to: when the acquired information is the information on the transmitting end, calculate the packet dropping statistic information according to data packet transmission status information in the information on the transmitting end acquired in a period; calculate the retransmission statistic information according to data packet retransmission information in the information on the transmitting end acquired in a period; calculate the correlation value statistic information according to acknowledgement (ACK) correlation value information in the information on the transmitting end acquired in a period; and calculate the RSSI statistic information according to ACK RSSIs in the information on the transmitting end acquired in a period.

Wherein the packet dropping statistic information is a packet drop ratio, the retransmission statistic information is a retry ratio, the duplicate statistic information is a duplicate ratio, the correlation value statistic information includes an average value of correlation values and a standard deviation of correlation values, and the RSSI statistic information includes an average value of RSSIs, a standard deviation of RSSIs and a gradient of RSSIs; and the trouble detection result includes one or more of the following results: a normal status, short-time fading, a low signal strength, and interference.

In another implementation, the above function of trouble detection may be configured in a chip (not shown) connected to the central processing unit 920, and the function of trouble detection is carried out under control of the central processing unit 920.

In this embodiment, the access point 900 may further include: a transceiver 904 and a power supply module 905, etc.; wherein, functions of the above components are similar to those of the prior art, such as reporting a final trouble detection result by the transceiver 904 to a gateway. It should be noted that the access point 900 does not necessarily include all the parts shown in FIG. 9. And furthermore, the access point 900 may include components not shown in FIG. 9, and the prior art may be referred to.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

### Embodiment 4

Embodiment 4 provides an access point. It differs from Embodiment 3 that in this embodiment, the access point executes steps 101-102 in Embodiment 1, and reports the first statistic data to the gateway, and the gateway executes step 103.

Hence, in this embodiment, the central processing unit 920 may be configured to: periodically acquire information relating to communication and/or a channel; statistically calculate the acquired information, so as to obtain first statistic data; and report the first statistic data to the gateway.

Wherein, the information includes: information on a receiving end and/or information on a transmitting end; and the information on the transmitting end is acquired by periodically transmitting probe packets. When the acquired information is the information on the transmitting end, the first statistic data include one or more pieces of the following information: packet dropping statistic information, retransmission statistic information, correlation value statistic information, and received signal strength indicator (RSSI) statistic information. And when the acquired information is the information on the receiving end, the first statistic data include one or more pieces of the following information: packet dropping statistic information, duplicate statistic information, correlation value statistic information, and received signal strength indicator (RSSI) statistic information.

Wherein, the central processing unit 920 may further be configured to: when the acquired information is the information on the receiving end, calculate the packet drop statistic information according to sequence numbers in the information on the receiving end acquired in a period; calculate the duplicate statistic information according to sequence numbers in the information on the receiving end acquired in a period; calculate the correlation value statistic information by measuring correlation values of data packets in the information on the receiving end acquired in a period; and calculate the RSSI statistic information by measuring RSSI values of data packets in the information on the receiving end acquired in a period.

Wherein, the central processing unit 920 may further be configured to: when the acquired information is the information on the transmitting end, calculate the packet dropping statistic information according to data packet transmission status information in the information on the transmitting end acquired in a period; calculate the retransmission statistic information according to data packet retransmission information in the information on the transmitting end acquired in a period; calculate the correlation value statistic information according to acknowledgement (ACK) correlation value information in the information on the transmitting end acquired in a period; and calculate the RSSI statistic information according to ACK RSSIs in the information on the transmitting end acquired in a period.

Wherein the packet dropping statistic information is a packet drop ratio, the retransmission statistic information is a retry ratio, the duplicate statistic information is a duplicate ratio, the correlation value statistic information includes an average value of correlation values and a standard deviation of correlation values, and the RSSI statistic information includes an average value of RSSIs, a standard deviation of RSSIs and a gradient of RSSIs; and the trouble detection result includes one or more of the following results: a normal status, short-time fading, a low signal strength, and interference.

In this embodiment, the access point 900 reports the first statistic data to the gateway via a transceiver.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

### Embodiment 5

Embodiment 5 provides a gateway, which interchanges information with the access point in Embodiment 4, receives the first statistic data transmitted by the access point in Embodiment 4, and executes step 103.

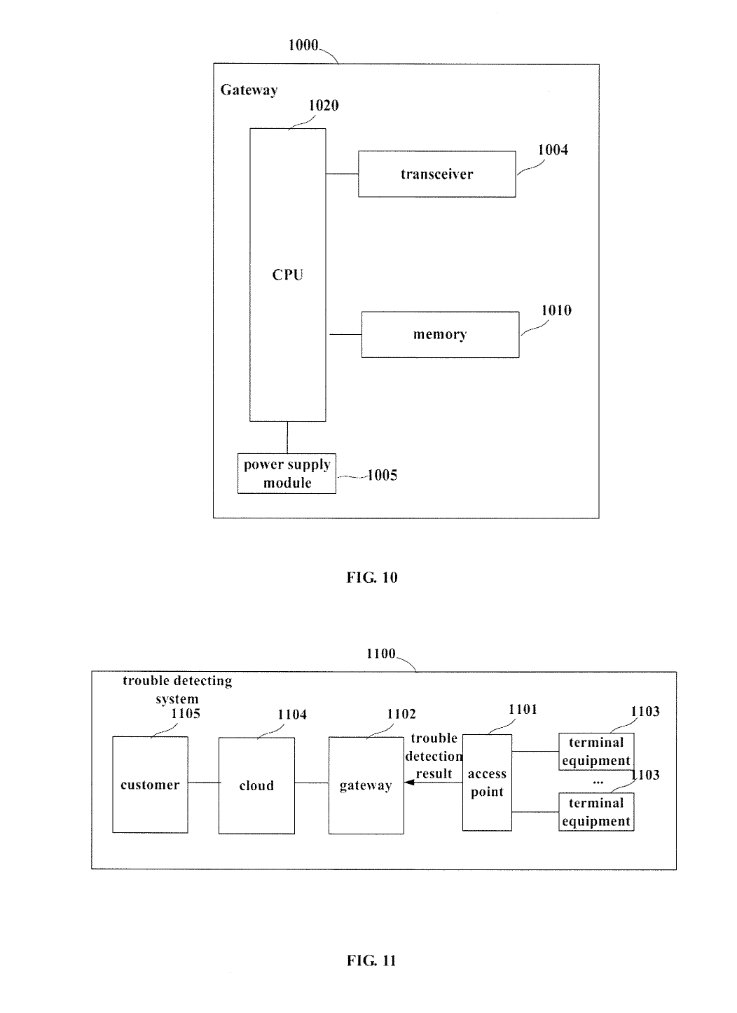

FIG. 10 is a schematic diagram of a structure of the gateway in this embodiment of the present invention. As shown in FIG. 10, the gateway 1000 may include: an interface (not shown), a central processing unit (CPU) 1020 and a memory 1010, the memory 1010 being coupled to the central processing unit 1020. Wherein, the memory 1010 may store various data, and may further store a program for trouble detection, and execute the program under control of the central processing unit 1020.

In an implementation, the central processing unit 1020 may be configured to: receive the first statistic data reported by the access point, and perform trouble detection by using the first statistic data and prestored training data, so as to obtain a trouble detection result.

Wherein, when the acquired information is the information on the transmitting end, the first statistic data include one or more pieces of the following information: packet dropping statistic information, retransmission statistic information, correlation value statistic information, and received signal strength indicator (RSSI) statistic information. And when the acquired information is the information on the receiving end, the first statistic data include one or more pieces of the following information: packet dropping statistic information, duplicate statistic information, correlation value statistic information, and received signal strength indicator (RSSI) statistic information.

Wherein the packet dropping statistic information is a packet drop ratio, the retransmission statistic information is a retry ratio, the duplicate statistic information is a duplicate ratio, the correlation value statistic information includes an average value of correlation values and a standard deviation of correlation values, and the RSSI statistic information includes an average value of RSSIs, a standard deviation of RSSIs and a gradient of RSSIs; and the trouble detection result includes one or more of the following results: a normal status, short-time fading, a low signal strength, and interference.

In another implementation, the above function of trouble detection may be configured in a chip (not shown) connected to the central processing unit 1020, and the function of trouble detection is carried out under control of the central processing unit 1020.

In this embodiment, the gateway 1000 may further include: a transceiver 1004 and a power supply module 1005, etc.; wherein, functions of the above components are similar to those of the prior art, such as receiving the first statistic data reported by the access point by the gateway 1000 via the transceiver 1004. It should be noted that the gateway 1000 does not necessarily include all the parts shown in FIG. 10. And furthermore, the gateway 1000 may include components not shown in FIG. 10, and the prior art may be referred to.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

### Embodiment 6

Embodiment 6 provides an access point. It differs from embodiment 3 and 4 that in this embodiment, the access point executes step 101 in Embodiment 1, and reports the acquired information relating to communication and/or a channel to the gateway, and the gateway executes steps 102 and 103 in Embodiment 1.

Hence, in this embodiment, the central processing unit 920 may be configured to: periodically acquire information relating to communication and/or a channel, and report the information relating to communication and/or a channel to the gateway.

Wherein, the information includes: information on a receiving end and/or information on a transmitting end; and the information on the transmitting end is acquired by periodically transmitting probe packets.

In this embodiment, the access point 900 reports the information relating to communication and/or a channel to the gateway via a transceiver.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

### Embodiment 7

Embodiment 7 provides a gateway, which interchanges information with the access point in Embodiment 6. It differs from the gateway in Embodiment 5 that it receives the information relating to communication and/or a channel reported by the access point in Embodiment 6, and executes steps 102 and 103 in Embodiment 1.

Hence, in this embodiment, the central processing unit 1020 may be configured to: receive the information relating to communication and/or a channel periodically reported by the access point; statistically calculate the acquired information, so as to obtain the first statistic data; and perform trouble detection by using the first statistic data and prestored training data, so as to obtain a trouble detection result.

Wherein, the information includes: information on a receiving end and/or information on a transmitting end; and the information on the transmitting end is acquired by periodically transmitting probe packets. When the acquired information is the information on the transmitting end, the first statistic data include one or more pieces of the following information: packet dropping statistic information, retransmission statistic information, correlation value statistic information, and received signal strength indicator (RSSI) statistic information. And when the acquired information is the information on the receiving end, the first statistic data include one or more pieces of the following information: packet dropping statistic information, duplicate statistic information, correlation value statistic information, and received signal strength indicator (RSSI) statistic information.

Wherein, the central processing unit 1020 may further be configured to: when the acquired information is the information on the receiving end, calculate the packet dropping statistic information according to sequence numbers in the information on the receiving end acquired in a period; calculate the duplicate statistic information according to sequence numbers in the information on the receiving end acquired in a period; calculate the correlation value statistic information by measuring correlation values of data packets in the information on the receiving end acquired in a period; and calculate the RSSI statistic information by measuring RSSI values of data packets in the information on the receiving end acquired in a period.

Wherein, the central processing unit 1020 may further be configured to: when the acquired information is the information on the transmitting end, calculate the packet dropping statistic information according to data packet transmission status information in the information on the transmitting end acquired in a period; calculate the retansmission statistic information according to data packet retransmission information in the information on the transmitting end acquired in a period; calculate the correlation value statistic information according to acknowledgement (ACK) correlation value information in the information on the transmitting end acquired in a period; and calculate the RSSI statistic information according to ACK RSSIs in the information on the transmitting end acquired in a period.

Wherein the packet dropping statistic information is a packet drop ratio, the retransmission statistic information is a retry ratio, the duplicate statistic information is a duplicate ratio, the correlation value statistic information includes an average value of correlation values and a standard deviation of correlation values, and the RSSI statistic information includes an average value of RSSIs, a standard deviation of RSSIs and a gradient of RSSIs; and the trouble detection result includes one or more of the following results: a normal status, short-time fading, a low signal strength, and interference.

In this embodiment, the gateway 1000 receives via the transceiver 1004 the information relating to communication and/or a channel reported by the access point.

In this embodiment, by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

### Embodiment 8

Embodiment 8 provides a trouble detecting system. FIG. 11 is a schematic diagram of a structure of the trouble detecting system 1100. As shown in FIG. 11, the trouble detecting system 1100 includes the access point 1101 in Embodiment 3 and a gateway 1102. The access point 1101 periodically acquires information relating to communication and/or a channel, statistically calculates the acquired information, so as to obtain first statistic data, performs trouble detection by using the first statistic data and prestored training data, so as to obtain a trouble detection result, and reports the trouble detection result to the gateway 1102; and the gateway 1102 receives the trouble detection result reported by the access point 1101. Wherein, Embodiment 3 may be referred for particular implementation of the access point 1101, the contents of which being incorporated herein, and being not going to be described herein any further.

In this embodiment, the trouble detecting system 1100 may further include terminal equipment 1103, cloud 1104 and customer 1105, etc., with functions of them being similar to those in the prior art. It should be noted that the trouble detecting system 1100 may include components not shown in FIG. 11, and the prior art may be referred to.

### Embodiment 9

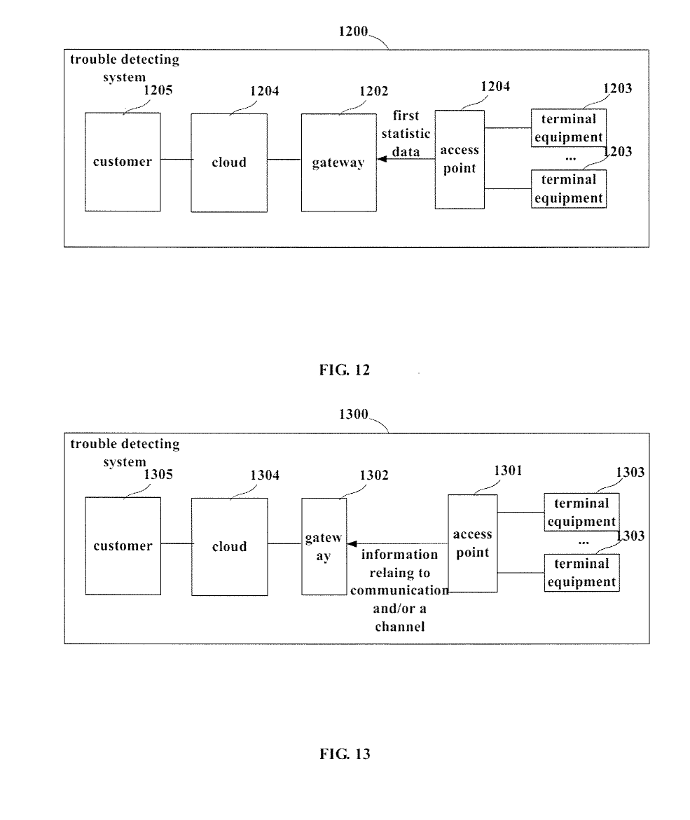

Embodiment 9 provides a trouble detecting system. FIG. 12 is a schematic diagram of a structure of the trouble detecting system 1200. As shown in FIG. 12, it differs from Embodiment 8 in that the trouble detecting system 1200 includes the access point 1201 in Embodiment 4 and the gateway 1202 in Embodiment 5.

In this embodiment, the access point 1201 periodically acquires information relating to communication and/or a channel, statistically calculates the acquired information, so as to obtain first statistic data, and reports the first statistic data to the gateway 1202. The gateway 1202 receives the first statistic data reported by the access point 1201, and performs trouble detection by using the first statistic data and prestored training data, so as to obtain a trouble detection result. Wherein, Embodiment 4 may be referred for particular implementation of the access point 1201, and Embodiment 5 may be referred for particular implementation of the gateway 1202, the contents of which being incorporated herein, and being not going to be described herein any further.

In this embodiment, the trouble detecting system 1200 may further include terminal equipment 1203, cloud 1204 and customer 1205, etc., with functions of them being similar to those in the prior art. It should be noted that the trouble detecting system 1200 may include components not shown in FIG. 12, and the prior art may be referred to.

### Embodiment 10

Embodiment 10 provides a trouble detecting system. FIG. 13 is a schematic diagram of a structure of the trouble detecting system 1300. As shown in FIG. 13, it differs from embodiments 8 and 9 in that the trouble detecting system 1300 includes the access point 1301 in Embodiment 6 and the gateway 1302 in Embodiment 7.

In this embodiment, the access point 1301 periodically acquires information relating to communication and/or a channel, and reports the information to the gateway 1302; the gateway 1302 receives the information relating to communication and/or a channel periodically reported by the access point 1301, statistically calculates the acquired information, so as to obtain first statistic data, performs trouble detection by using the first statistic data and prestored training data, so as to obtain a trouble detection result. Wherein, Embodiment 6 may be referred for particular implementation of the access point 1301, and Embodiment 7 may be referred for particular implementation of the gateway 1302, the contents of which being incorporated herein, and being not going to be described herein any further.

In this embodiment, the trouble detecting system 1300 may further include terminal equipment 1303, cloud 1304 and customer 1305, etc., with functions of them being similar to those in the prior art. It should be noted that the trouble detecting system 1300 may include components not shown in FIG. 13, and the prior art may be referred to.

It can be seen from the above trouble detecting systems that by periodically obtaining the information relating to communication and/or a channel, statistically processing the information and performing trouble detection on the statistically processed information, not only multiple possible communication troubles may be detected, but also the signaling overhead is relatively low, thereby achieving low complexity.

An embodiment of the present invention further provides a computer-readable program, wherein when the program is executed in a trouble detecting apparatus, the program enables a computer to carry out the trouble detecting method as described in Embodiment 1.

An embodiment of the present invention further provides a storage medium in which a computer-readable program is stored, wherein the computer-readable program enables a computer to carry out the trouble detecting method as described in Embodiment 1.

The above apparatuses and methods of the present invention may be implemented by hardware, or by hardware in combination with software. The present invention relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

Regarding implementations containing the above embodiments, following supplements are further disclosed.

Supplement 1. A trouble detecting apparatus, characterized in that the apparatus includes:

a first acquiring unit configured to periodically acquire information relating to communication and/or a channel;

a first counting unit configured to statistically calculate the acquired information, so as to obtain first statistic data; and

a first detecting unit configured to perform trouble detection by using the first statistic data and prestored training data, so as to obtain a trouble detection result.

Supplement 2. The apparatus according to supplement 1, wherein the information includes: information on a receiving end and/or information on a transmitting end;

and the first acquiring unit acquires the information on the transmitting end by periodically transmitting probe packets.

Supplement 3. The apparatus according to supplement 2, wherein when the information acquired by the first acquiring unit is the information on the receiving end, the first statistic data include one or more pieces of the following information:

packet dropping statistic information, duplicate statistic information, correlation value statistic information, and received signal strength indicator (RSSI) statistic information;

and when the information acquired by the first acquiring unit is the information on the transmitting end, the first statistic data include one or more pieces of the following information:

packet dropping statistic information, retansmission statistic information, correlation value statistic information, and received signal strength indicator (RSSI) statistic information.

Supplement 4. The apparatus according to supplement 3, wherein when the information acquired by the first acquiring unit is the information on the receiving end, the first counting unit includes:

a first calculating unit configured to calculate the packet dropping statistic information according to sequence numbers in the information on the receiving end acquired in a period;

a second calculating unit configured to calculate the duplicate statistic information according to sequence numbers in the information on the receiving end acquired in a period;

a third calculating unit configured to calculate the correlation value statistic information by measuring correlation values of data packets in the information on the receiving end acquired in a period; and a fourth calculating unit configured to calculate the RSSI statistic information by measuring RSSI values of data packets in the information on the receiving end acquired in a period.

Supplement 5. The apparatus according to supplement 3, wherein when the information acquired by the first acquiring unit is the information on the transmitting end, the first counting unit includes:

a fifth calculating unit configured to calculate the packet dropping statistic information according to data packet transmission status information in the information on the transmitting end acquired in a period;

a sixth calculating unit configured to calculate the retransmission statistic information according to data packet retransmission information in the information on the transmitting end acquired in a period;

a seventh calculating unit configured to calculate the correlation value statistic information according to acknowledgement (ACK) correlation value information in the information on the transmitting end acquired in a period; and an eighth calculating unit configured to calculate the RSSI statistic information according to ACK RSSIs in the information on the transmitting end acquired in a period.

Supplement 6. The apparatus according to supplement 4 or 5, wherein the packet dropping statistic information is a packet drop ratio, the retransmission statistic information is a retransmission ratio, the statistic duplicate information is a duplicate ratio, the correlation value statistic information includes an average value of correlation values and a standard deviation of correlation values, and the RSSI statistic information includes an average value of RSSIs, a standard deviation of RSSIs and a gradient of RSSIs.

Supplement 7. The apparatus according to supplement 1, wherein the trouble detection result includes one or more of the following results: a normal status, short-time fading, a low signal strength, and interference.

Supplement 8. A trouble detecting system, including a gateway and an access point, characterized in that:

the access point periodically acquires information relating to communication and/or a channel, and reports the information to the gateway;

and the gateway statistically calculates the acquired information, so as to obtain first statistic data, and performs trouble detection by using the first statistic data and prestored training data, so as to obtain a trouble detection result.

Supplement 9. A trouble detecting system, including a gateway and an access point, characterized in that:

the access point periodically acquires information relating to communication and/or a channel, statistically calculates the acquired information, so as to obtain first statistic data, performs trouble detection by using the first statistic data and prestored training data, so as to obtain a trouble detection result, and reports the trouble detection result to the gateway.

Supplement 10. A trouble detecting system, including a gateway and an access point, characterized in that:

the access point periodically acquires information relating to communication and/or a channel, statistically calculates the acquired information, so as to obtain first statistic data, and reports the first statistic data to the gateway;

and the gateway performs trouble detection by using the first statistic data and prestored training data, so as to obtain a trouble detection result.

Supplement 11. A trouble detecting method, characterized in that the method includes:

periodically acquiring information relating to communication and/or a channel;

statistically calculating the acquired information, so as to obtain first statistic data;

and performing trouble detection by using the first statistic data and prestored training data, so as to obtain a trouble detection result.

Supplement 12. The method according to supplement 11, wherein the information includes: information on a receiving end and/or information on a transmitting end;

and the information on the transmitting end is acquired by periodically transmitting probe packets.

Supplement 13. The method according to supplement 12, wherein when the acquired information is the information on the receiving end, the first statistic data include one or more pieces of the following information:

packet dropping statistic information, duplicate statistic information, correlation value statistic information, and received signal strength indicator (RSSI) statistic information;

and when the acquired information is the information on the transmitting end, the first statistic data include one or more pieces of the following information:

packet dropping statistic information, retransmission statistic information, correlation value statistic information, and received signal strength indicator (RSSI) statistic information.

Supplement 14. The method according to supplement 13, wherein when the acquired information is the information on the receiving end, the statistically calculating the acquired information, so as to obtain first statistic data, includes:

calculating the packet dropping statistic information according to sequence numbers in the information on the receiving end acquired in a period;

calculating the duplicate statistic information according to sequence numbers in the information on the receiving end acquired in a period;

calculating the correlation value statistic information by measuring correlation values of data packets in the information on the receiving end acquired in a period; and

calculating the RSSI statistic information by measuring RSSI values of data packets in the information on the receiving end acquired in a period.

Supplement 15. The method according to supplement 13, wherein when the acquired information is the information on the transmitting end, the statistically calculating the acquired information, so as to obtain first statistic data, includes:

calculating the packet dropping statistic information according to data packet transmission status information in the information on the transmitting end acquired in a period;

calculating the retransmission statistic information according to data packet retransmission information in the information on the transmitting end acquired in a period;

calculating the correlation value statistic information according to acknowledgement (ACK) correlation value information in the information on the transmitting end acquired in a period; and calculating the RSSI statistic information according to ACK RSSIs in the information on the transmitting end acquired in a period.

Supplement 16. The method according to supplement 14 or 15, wherein the packet dropping statistic information is a packet drop ratio, the retransmission statistic information is a retry ratio, the duplicate statistic information is a duplicate ratio, the correlation value statistic information includes an average value of correlation values and a standard deviation of correlation values, and the RSSI statistic information includes an average value of RSSIs, a standard deviation of RSSIs and a gradient of RSSIs.

Supplement 17. The method according to supplement 11, wherein the trouble detection result includes one or more of the following results: a normal status, short-time fading, a low signal strength, and interference.

1. A trouble detecting apparatus, characterized in that the apparatus comprises:
a first acquiring unit configured to periodically acquire information relating to communication and/or a channel;
a first counting unit configured to statistically calculate the acquired information, so as to obtain first statistic data; and
a first detecting unit configured to perform trouble detection by using the first statistic data and prestored training data, so as to obtain a trouble detection result.

2. The apparatus according to claim 1, wherein the information comprises:
information on a receiving end and/or information on a transmitting end; and
the first acquiring unit acquires the information on the transmitting end by periodically transmitting probe packets.

3. The apparatus according to claim 2, wherein when the information acquired by the first acquiring unit is the information on the receiving end, the first statistic data comprise one or more pieces of the following information:
packet dropping statistic information, duplicate statistic information, correlation value statistic information, and received signal strength indicator (RSSI) statistic information; and
when the information acquired by the first acquiring unit is the information on the transmitting end, the first statistic data comprise one or more pieces of the following information:
packet dropping statistic information, retransmission statistic information, correlation value statistic information, and received signal strength indicator (RSSI) statistic information.

4. The apparatus according to claim 3, wherein when the information acquired by the first acquiring unit is the information on the receiving end, the first counting unit comprises:
a first calculating unit configured to calculate the packet dropping statistic information according to sequence numbers in the information on the receiving end acquired in a period;
a second calculating unit configured to calculate the duplicate statistic information according to sequence numbers in the information on the receiving end acquired in a period;
a third calculating unit configured to calculate the correlation value statistic information by measuring correlation values of data packets in the information on the receiving end acquired in a period; and
a fourth calculating unit configured to calculate the RSSI statistic information by measuring RSSI values of data packets in the information on the receiving end acquired in a period.

5. The apparatus according to claim 3, wherein when the information acquired by the first acquiring unit is the information on the transmitting end, the first counting unit comprises:
a fifth calculating unit configured to calculate the packet dropping statistic information according to data packet transmission status information in the information on the transmitting end acquired in a period;
a sixth calculating unit configured to calculate the retransmission statistic information according to data packet retransmission information in the information on the transmitting end acquired in a period;
a seventh calculating unit configured to calculate the correlation value statistic information according to acknowledgement (ACK) correlation value information in the information on the transmitting end acquired in a period; and
an eighth calculating unit configured to calculate the RSSI statistic information according to ACK RSSIs in the information on the transmitting end acquired in a period.

6. The apparatus according to claim 4, wherein the packet dropping statistic information is a packet drop ratio, the retransmission statistic information is a retransmission ratio, the duplicate statistic information is a duplicate ratio, the correlation value statistic information comprises an average value of correlation values and a standard deviation of correlation values, and the RSSI statistic information comprises an average value of RSSIs, a standard deviation of RSSIs and a gradient of RSSIs.

7. The apparatus according to claim 1, wherein the trouble detection result comprises one or more of the following results: a normal status, short-time fading, a low signal strength, and interference.

8. A trouble detecting system, comprising a gateway and an access point, characterized in that:
the access point periodically acquires information relating to communication and/or a channel, and reports the information to the gateway; and
the gateway statistically calculates the acquired information, so as to obtain first statistic data, and performs trouble detection by using the first statistic data and prestored training data, so as to obtain a trouble detection result.

9. A trouble detecting system, comprising a gateway and an access point, characterized in that:
the access point periodically acquires information relating to communication and/or a channel, statistically calculates the acquired information, so as to obtain first statistic data, performs trouble detection by using the first statistic data and prestored training data, so as to obtain a trouble detection result, and reports the trouble detection result to the gateway.

10. A trouble detecting system, comprising a gateway and an access point, characterized in that:
the access point periodically acquires information relating to communication and/or a channel, statistically calculates the acquired information, so as to obtain first statistic data, and reports the first statistic data to the gateway; and
the gateway performs trouble detection by using the first statistic data and prestored training data, so as to obtain a trouble detection result.
